(19) United States
(12) Patent Application Publication
(10) Pub. No.: US 2013/0050821 A1
(43) Pub. Date: Feb. 28, 2013

(54) Reflective Three-Dimensional Display Device and Method for Manufacturing the Same

(71) Applicants: Ker-Win Wang, Changhua City (TW); Jun-Fu Chuang, New Taipei CIty (TW)

(72) Inventors: Ker-Win Wang, Changhua City (TW); Jun-Fu Chuang, New Taipei CIty (TW)

(73) Assignee: NATIONAL CHANGHUA UNIVERSITY OF EDUCATION, Changhua City (TW)

(21) Appl. No.: 13/529,499

(22) Filed: Jun. 21, 2012

(30) Foreign Application Priority Data
Aug. 22, 2011 (TW) 100130039

(51) Int. Cl. G02B 27/22; B05D 5/06

(52) U.S. Cl. 359/479; 427/162

(57) ABSTRACT

A reflective 3D display device and manufacturing method thereof This method includes following steps: providing a template with at least one concave parts-trap and at least one metallic microsphere, and tilting the template to form a first included angle, between the concave parts-trap and a horizontal plane, in a first direction, and a second included angle, between the concave parts-trap and the horizontal, in a second direction. When the metallic microspheres are disposed in the concave parts-trap, the metallic microspheres would self-organize to intrinsic potential minima, and then an adhesive layer and a gel are provided for removing which and fixing the relative positions between which respectively. A portion of each metallic microsphere is exposed form the gel, which is used to reflect light to 3D space, such that 3D images viewable with naked eye are achieved and the perspective phenomenon occurring in 3D images is reduced.

### CROSS-REFERENCE TO RELATED APPLICATION

This application claims the benefit of Taiwan Patent Application No. 100130039, filed on Aug. 22, 2011, in the Taiwan Intellectual Property Office, the disclosure of which is incorporated herein in its entirety by reference.

### BACKGROUND OF THE INVENTION

1. Field of the Invention

The present invention generally relates to a display device and a method for manufacturing the same, in particular to a multi-view reflective three-dimension (3D) display device and a method for manufacturing the same.

2. Description of the Related Art

With advances in science and technology, modern people pay more and more attention to high realistic images. With advances in 3D imaging, 3D movies are introduced to many movie theaters to satisfy modern people's requirements.

Traditional 3D display technologies provide 3D vision for a user through binocular parallax between the user's eyes. Thus, the user must wear specific glasses or situated at a particular position to watch 3D images. Volumetric 3D display technologies can directly generate 3D images for the user to experience 3D vision with naked eye.

“Perspective phenomenon” tends to occur in currently available volumetric 3D display technologies, which means the user may see the objects behind 3D images when watching 3D images, such that the objects in 3D images are much different from the real 3D object.

### SUMMARY OF THE INVENTION

Therefore, it is a primary objective of the present invention to provide a reflective 3D display device and a method for manufacturing the same to achieve the effect of enhancing the image brightness and contrast and reducing the “perspective phenomenon” occurring in 3D images.

To achieve the foregoing objective, the present invention provides a method for manufacturing reflective 3D display device, which is applicable for the screen of a display device. The method comprises the following steps of: providing a template with at least one concave parts-trap and at least one metallic microsphere, wherein the at least one metallic microsphere may be spherical, concave, polyhedral or geometrical; and tilting the template to form a first included angle, between the concave parts-trap and a horizontal plane, in a first direction, and a second included angle, between the concave parts-trap and the horizontal plane, in a second direction. Wherein, the first and second included angles may be, for example, 0˜15 degrees, and the first included angle may be equal to the second included angle.

After the template is tilted, the metallic microspheres in the concave parts-trap self-organize to intrinsic potential minima. The arrangement of the metallic microspheres may be simple cubic (s.c), body-centered cubic (b.c.c) or face-centered cubic (f.c.c), which varies with the first and second included angles. Besides, the metallic microspheres may be mixed with isopropyl alcohol (IPA) and then the IPA with the metallic microspheres is dripped in the concave parts-trap to dispose the metallic microspheres in the concave parts-trap.

With the aforementioned steps, the metallic microspheres self-organize to intrinsic potential minima, such that the metallic microspheres will be in an orderly arrangement according to the potential of each metallic microsphere. Next, an adhesive layer is providing for removing the metallic microspheres from the concave parts-trap.

Finally, a gel body (or curable polymer) is provided for fixing the relative positions between the metallic microspheres whose diameters are 800 micrometer. The thickness of the gel body may be, for example, between 0.1˜5.0 millimeters (mm) and may be, preferably, 2˜3 mm, which varies with the size of the metallic microspheres. Wherein, a portion of each metallic microsphere exposes from the gel body (or curable polymer) in order to reflect light to 3D space, such that 3D images viewable with naked eye and multi-view 3D images are achieved, and the perspective phenomenon occurring in 3D image is reduced. In addition, the method in accordance with the present invention further comprises the step of removing the adhesion layer from the metallic microspheres after the step that the gel body (or curable polymer) is provided for fixing the relative positions between each metallic microsphere. The exposed portions of the metallic microspheres are used to act as the surfaces for reflecting light.

Moreover, the present invention further provides a reflective 3D display device which comprises a light emitting diode array, a focusing lens and a reflective display screen. The reflective display screen comprises a plurality of metallic microspheres for reflecting light to 3D space and a gel body (or curable polymer) for fixing the relative position of the metal microspheres. Wherein, the plurality of metallic microspheres are embedded in the gel body (or curable polymer) and a portion of each metallic microsphere exposes from the gel for reflecting light to 3D space in order to produce 3D images viewable with naked eye and multi-view 3D images, and reduce the perspective phenomenon occurs in 3D images.

In summary, the reflective 3D display device and the method for manufacturing the same according to the present invention has the following advantages:

(1) The reflective 3D display device and the method for manufacturing the same according to the present invention make the metallic microspheres self-organize and arrange themselves to form simple cubic structure, body-centered cubic structure or face-centered cubic structure by tilting the template to forming the first and the second included angles between the concave parts-trap and the horizontal plane. Thus, the exposed portions of the metallic microspheres can be used to act as the surfaces for reflecting light from well aligned imaging pixels to specific orientations in 3D space, such that 3D images viewable with naked eye and multi-view 3D images are achieved and the perspective phenomenon occurring in the 3D image is reduced. The metallic microspheres may be spherical, polyhedral or microspheres made of other materials with optical reflective feature.

In order to make the technical characteristics and the advantages of the present invention become more apparent, the detailed description of the preferred embodiments will be illustrated as follows.

### BRIEF DESCRIPTION OF THE DRAWINGS

The detailed structure, operating principle and effects of the present invention will now be described in more details hereinafter with reference to the accompanying drawings that show various embodiments of the invention as follows.

FIG. 1 is the first schematic view of the method for manufacturing the reflective 3D display device in accordance with the present invention;

FIG. 2 is the second schematic view of the method for manufacturing the reflective 3D display device in accordance with the present invention;

FIG. 3 is the third schematic view of the method for manufacturing the reflective 3D display device in accordance with the present invention;

FIG. 4 is the fourth schematic view of the method for manufacturing the reflective 3D display device in accordance with the present invention;

FIG. 5 is the fifth schematic view of the method for manufacturing the reflective 3D display device in accordance with the present invention;

FIG. 6 is the sixth schematic view of the method for manufacturing the reflective 3D display device in accordance with the present invention;

FIG. 7 is the seventh schematic view of the method for manufacturing the reflective 3D display device in accordance with the present invention;

FIG. 8 is the eighth schematic view of the method for manufacturing the reflective 3D display device in accordance with the present invention;

FIG. 9 is the ninth schematic view of the method for manufacturing the reflective 3D display device in accordance with the present invention;

FIG. 10 is the tenth schematic view of the method for manufacturing the reflective 3D display device in accordance with the present invention;

FIG. 11 is the eleventh schematic view of the method for manufacturing the reflective 3D display device in accordance with the present invention;

FIG. 12 is the flow chart of the method for manufacturing the reflective 3D display device in accordance with the present invention;

FIG. 13 is the schematic view of the binocular parallax in each direction of the method for manufacturing the reflective 3D display device in accordance with the present invention; and

FIG. 14 is the schematic view of the metallic microspheres arranged to form a body-centered cubic structure of the method for manufacturing the reflective 3D display device in accordance with the present invention.

FIGS. 15˜17 are the schematic view of the reflective 3D display device in accordance with the present invention.

### DETAILED DESCRIPTION OF THE PREFERRED EMBODIMENTS

The technical content of the present invention will become apparent by the detailed description of the following embodiments and the illustration of related drawings as follows.

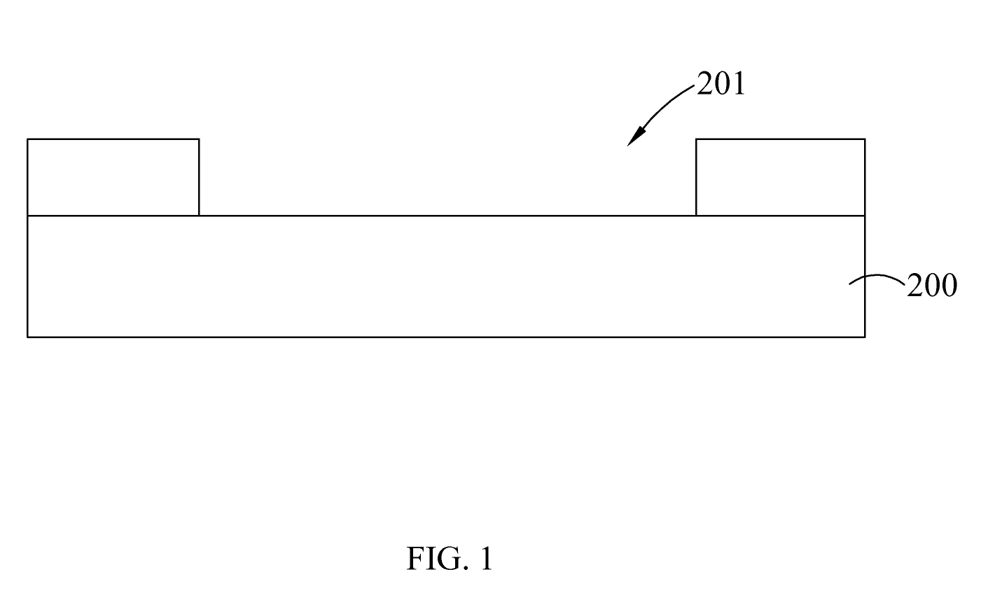

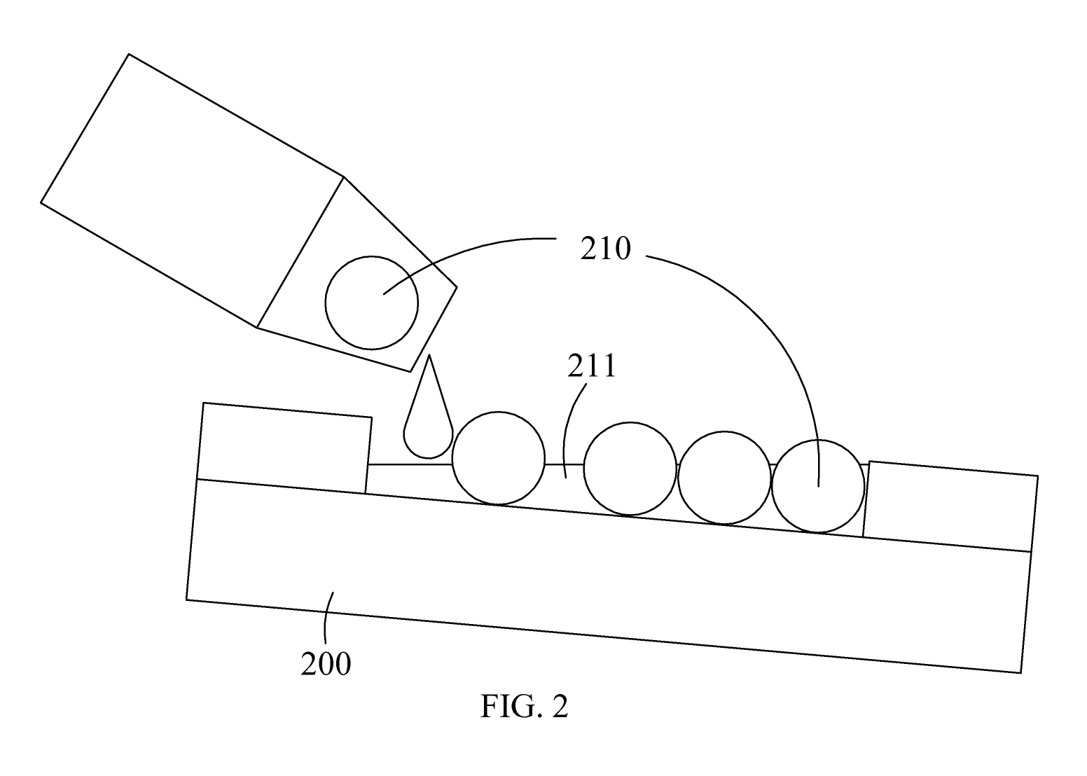

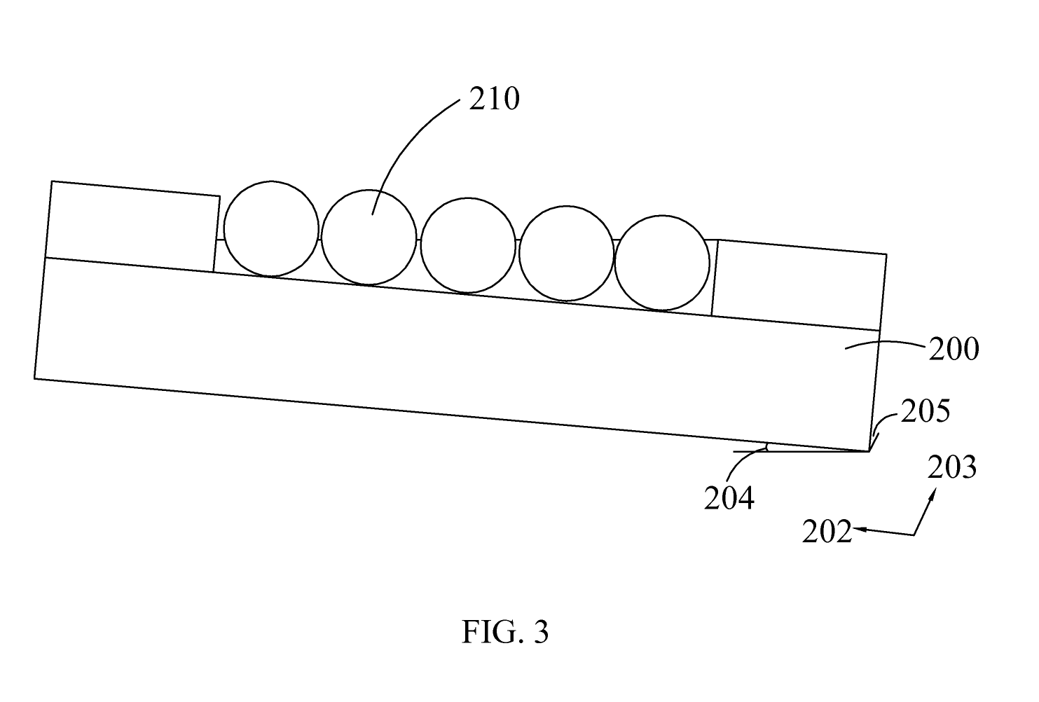

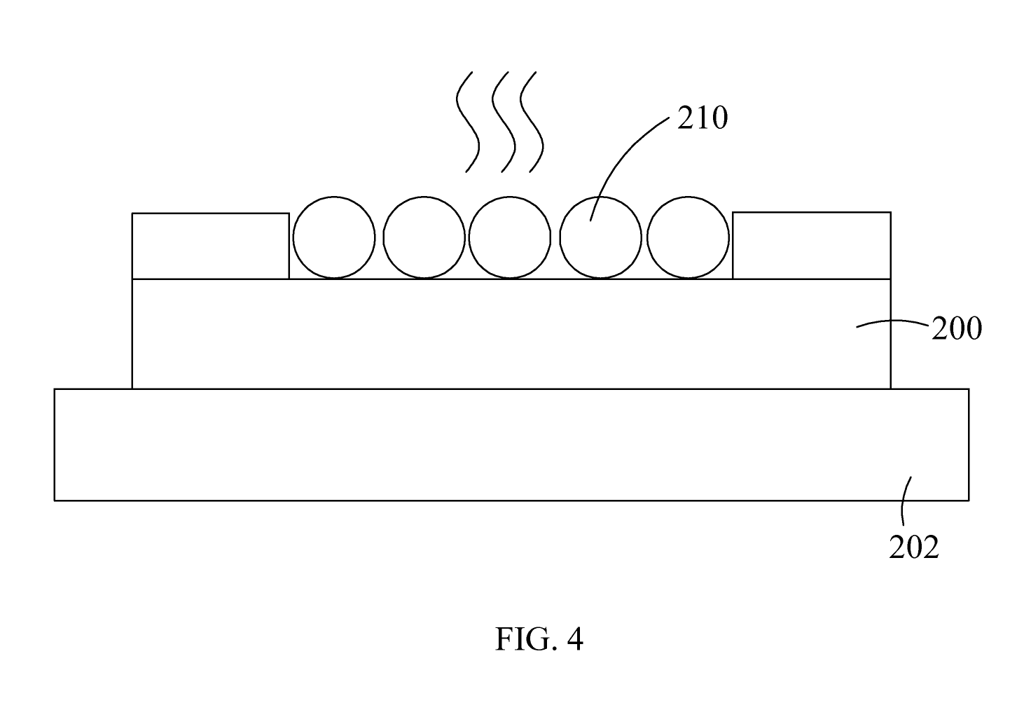

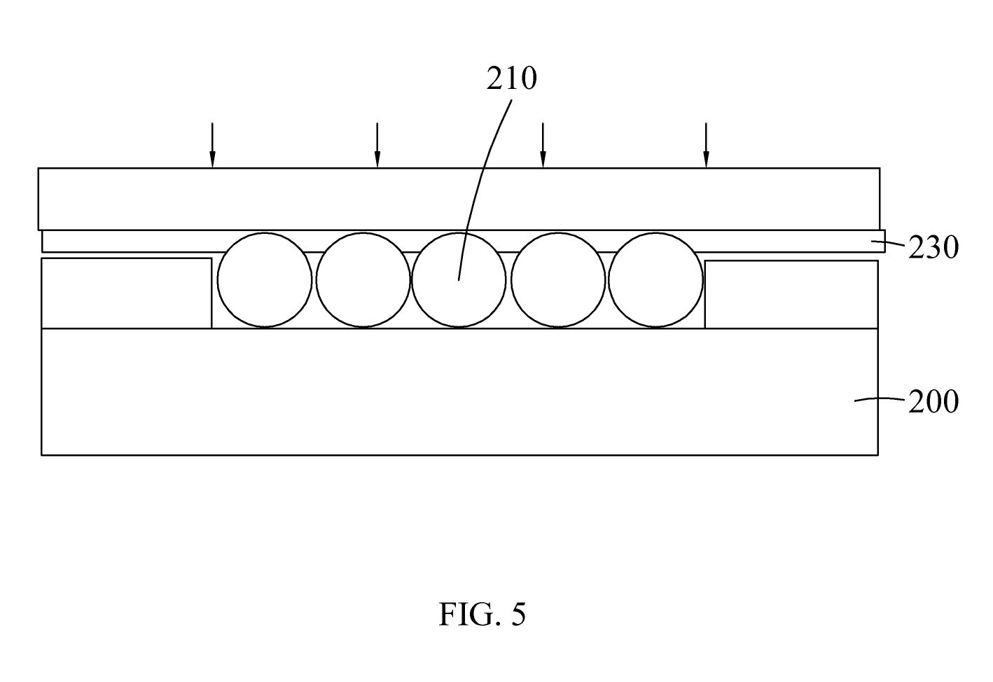

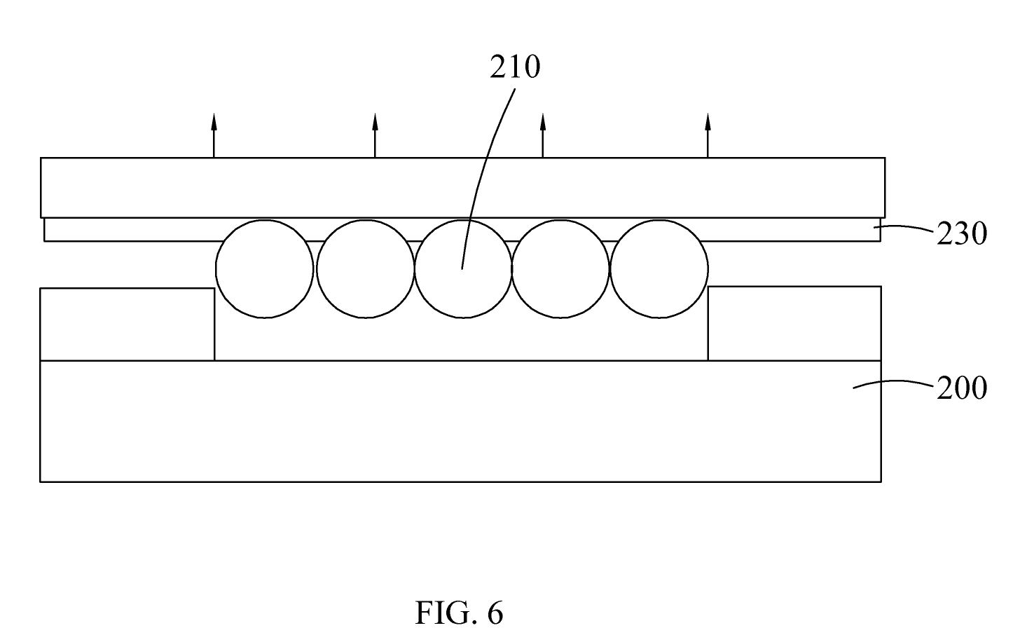

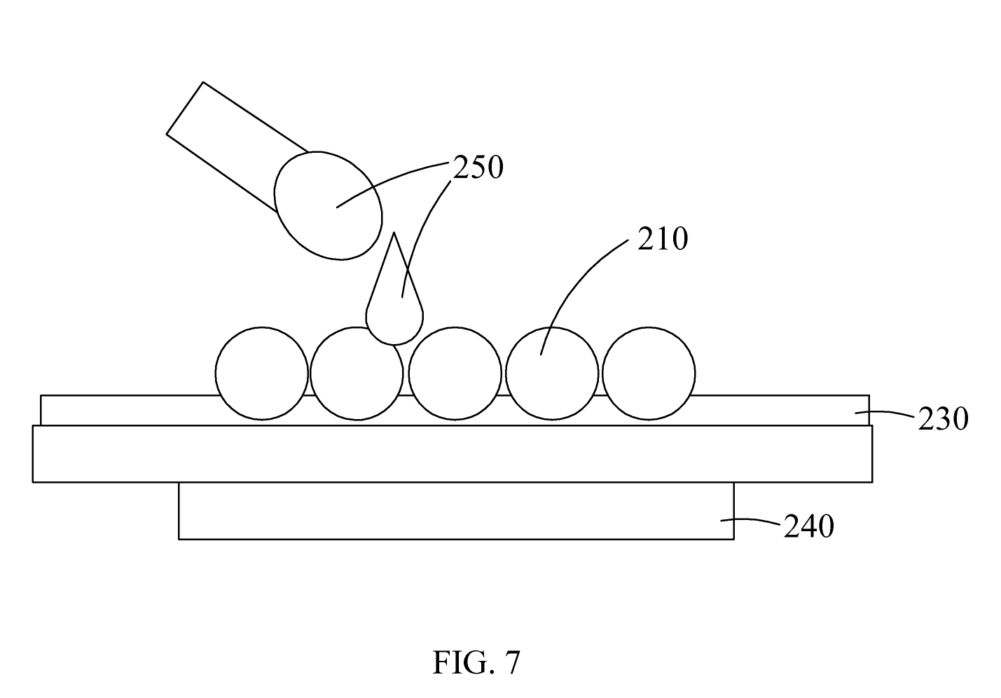

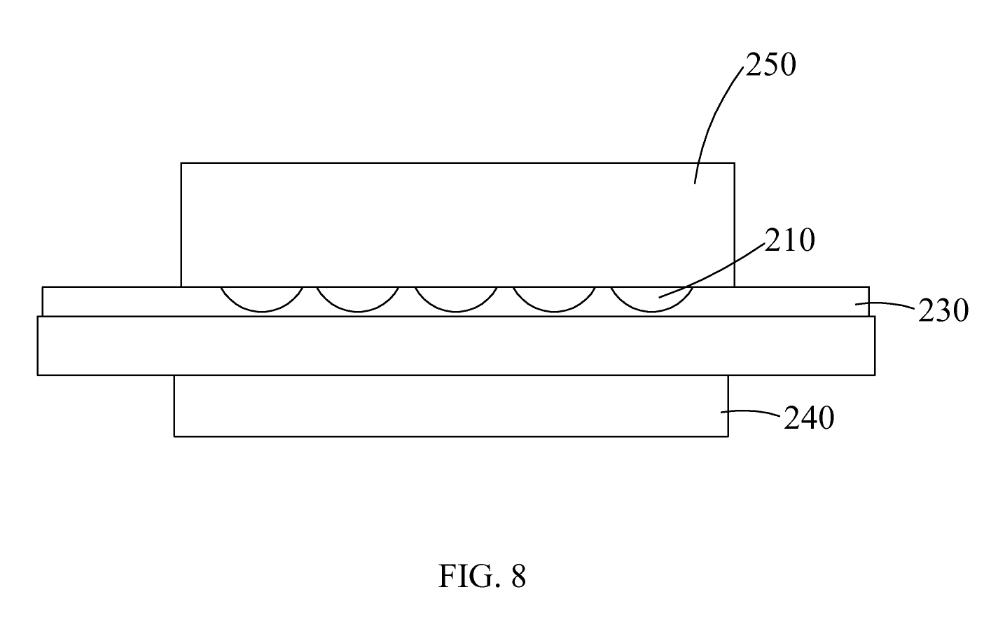

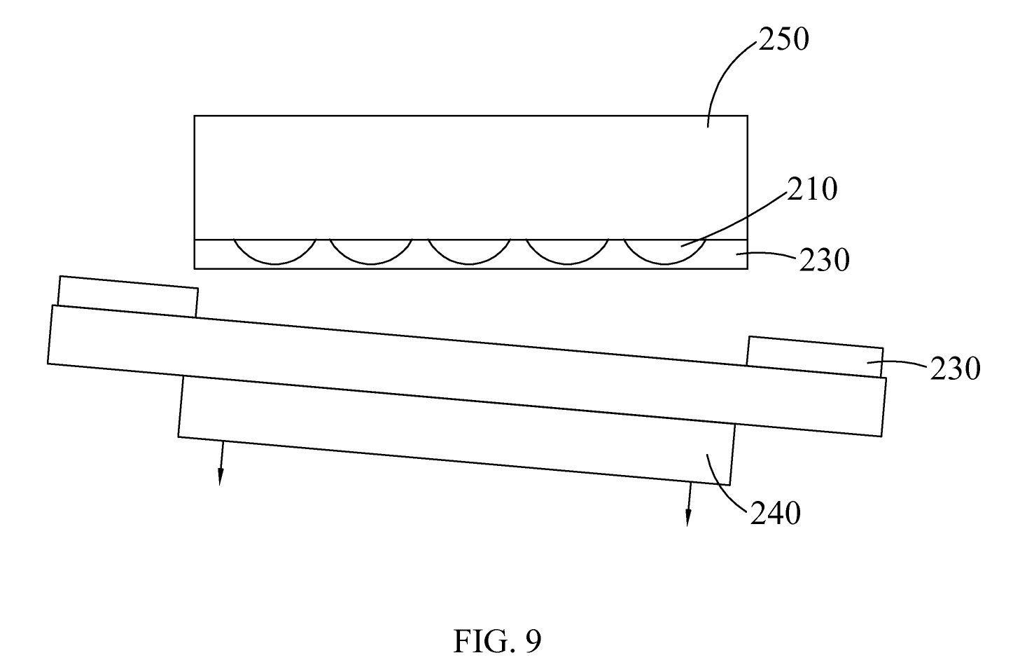

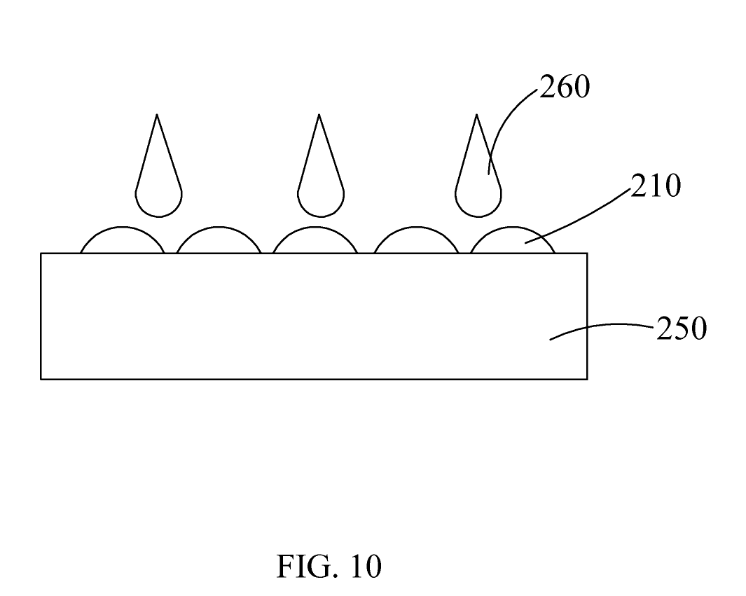

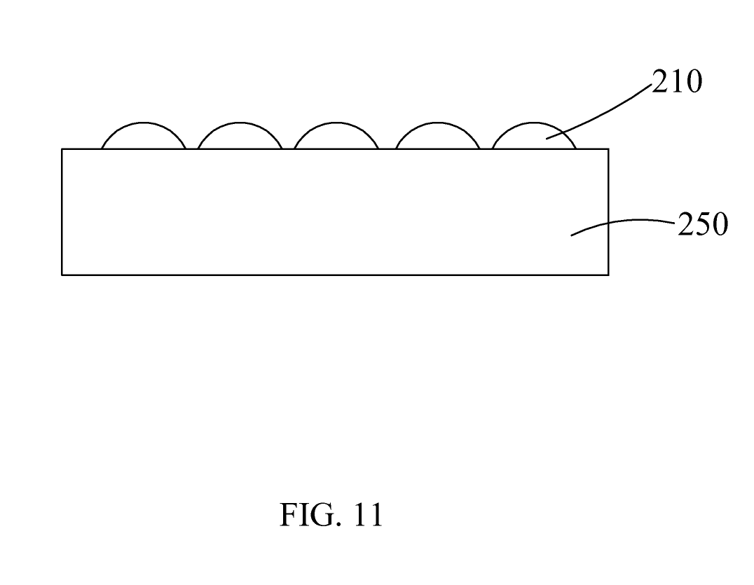

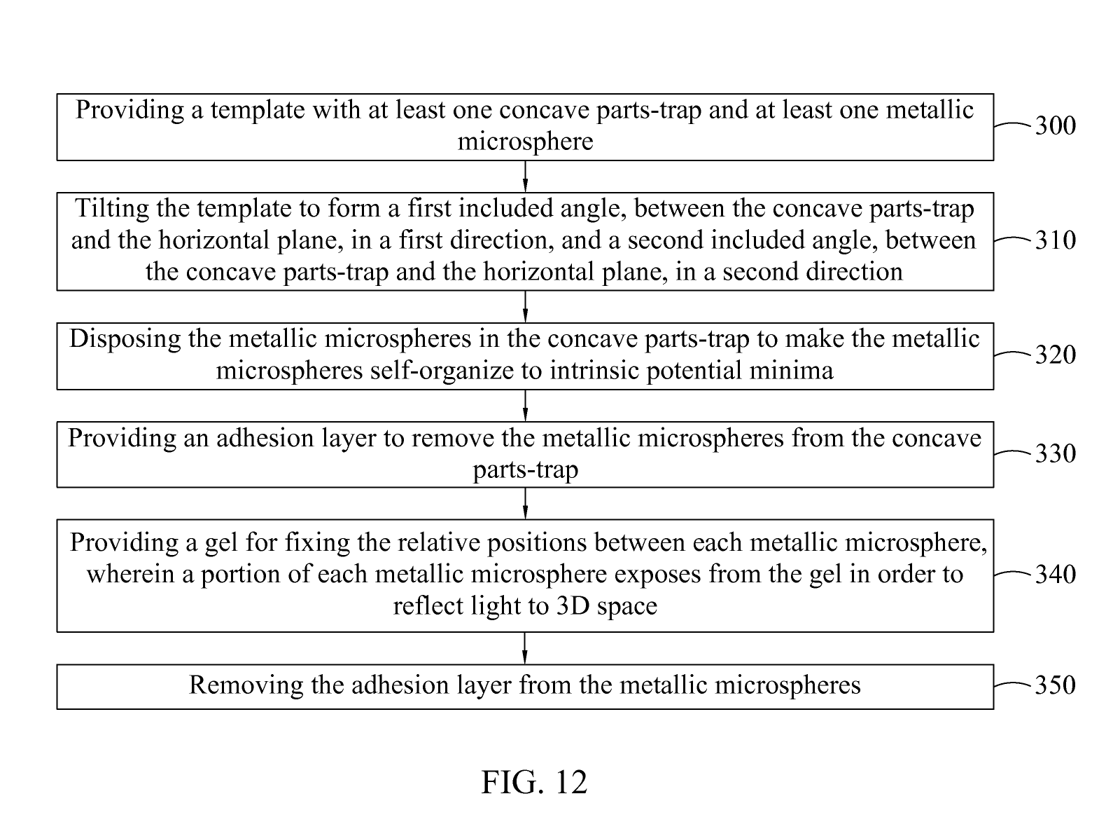

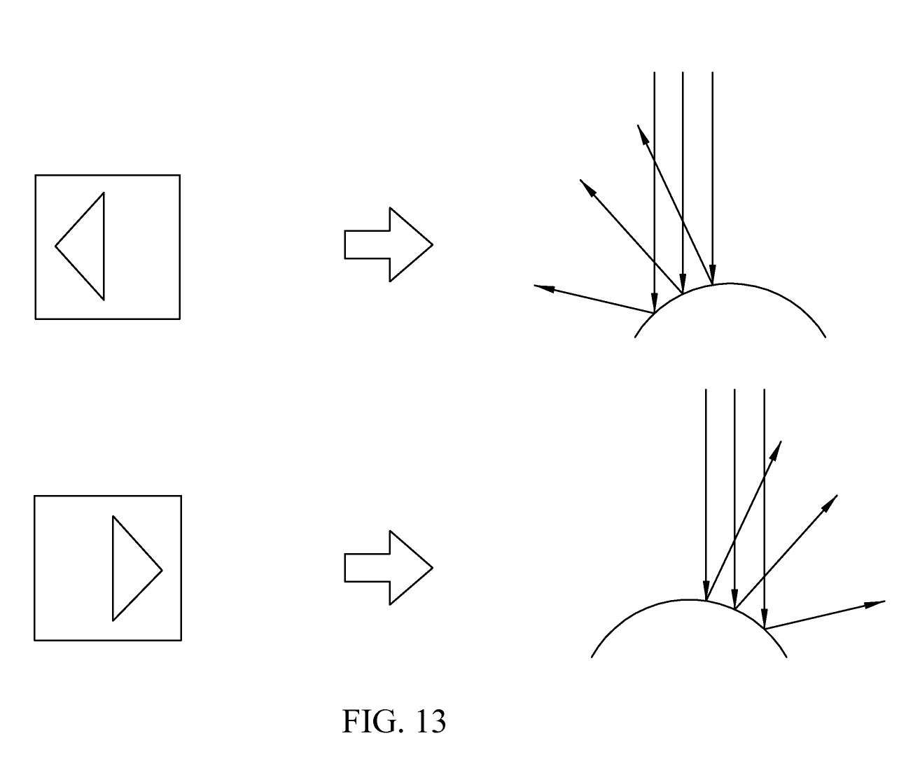

Please refer to FIG. 1˜FIG. 12. FIG. 1 is the first schematic view of the method for manufacturing the reflective 3D display device in accordance with the present invention. FIG. 2 is the second schematic view of the method for manufacturing the reflective 3D display device in accordance with the present invention. FIG. 3 is the third schematic view of the method for manufacturing the reflective 3D display device in accordance with the present invention. FIG. 4 is the fourth schematic view of the method for manufacturing the reflective 3D display device in accordance with the present invention. FIG. 5 is the fifth schematic view of the method for manufacturing the reflective 3D display device in accordance with the present invention. FIG. 6 is the sixth schematic view of the method for manufacturing the reflective 3D display device in accordance with the present invention. FIG. 7 is the seventh schematic view of the method for manufacturing the reflective 3D display device in accordance with the present invention. FIG. 8 is the eighth schematic view of the method for manufacturing the reflective 3D display device in accordance with the present invention. FIG. 9 is the ninth schematic view of the method for manufacturing the reflective 3D display device in accordance with the present invention. FIG. 10 is the tenth schematic view of the method for manufacturing the reflective 3D display device in accordance with the present invention. FIG. 11 is the eleventh schematic view of the method for manufacturing the reflective 3D display device in accordance with the present invention. FIG. 12 is the flow chart of the method for manufacturing the reflective 3D display device in accordance with the present invention. As shown in FIG. 1˜FIG. 12, the method for manufacturing the reflective 3D display device in accordance with the present invention is applicable for the screen of a display device, which comprises the follows steps. First, in the step 300, the metallic microspheres 210 and the template 200 with the concave parts-trap 201 (as shown FIG. 1), and the depth of concave parts-trap 201 is 0.6 millimeters (mm) The shape of the metallic microspheres may be spherical, concave, polyhedral, geometrical or non-spherical. Next step is the step 310. In the step 310, the template 200 is tilted (as shown in FIG. 2 and FIG. 3), which form the first included angle 204, between the concave parts-trap 201 and the horizontal plane, in the first direction 202, and the second included angle 205, between the concave parts-trap 201 and the horizontal plane, in the second direction 203. The first and the second included angles 204, 205 may be, for example, 0˜15 degrees. Besides, the first included angle 204 may be equal to the second included angle 205. Preferably, the first direction 202 and the second direction 203 are perpendicular to each other.

The next step is the step 320. In the step 320, the metallic microspheres 210 are disposed in the concave parts-trap 201 to make which self-organize to intrinsic potential minima. Wherein, the metallic microspheres 210 can be mixed with isopropyl alcohol 211 (IPA) to form a suspension of the metallic microspheres 210 in isopropyl alcohol 211 and then the suspension will be dripped in the concave parts-trap 201. The aforementioned method can evenly distribute the metallic microspheres over the concave parts-trap 201 and is helpful to arrange the metallic microspheres 210 in the concave parts-trap 201. After the metallic microspheres 210 are arranged in the concave parts-trap 201, the isopropyl alcohol 211 may be removed form the metallic microspheres 210 by a heater (as shown in FIG. 4).

It is worthy to point out that the metallic microspheres 210 will self-organize to be arranged form low intrinsic potential to high intrinsic potential when the concave parts-trap 201 is tilted. That is the reason why the template 200 must be tilted to form the first and the second included angles 204, 205 between the concave parts-trap 201 and the horizontal plane. Wherein, the arrangement of the metallic microspheres 210 may be simple cubic, body-centered cubic (b.c.c) or face-centered cubic (f.c.c).

Next, in the step 330, the adhesion layer 230 is provided for removing the metallic microspheres 210 from the concave parts-trap 201 (as shown in FIG. 5 and FIG. 6). The adhesion layer 230 may be disposed on another substrate. The metallic microspheres 210 can be removed from the concave parts-trap 201 by sticking the adhesion layer 230 on one side of the metallic microspheres 210, which may be the blue film tape. After that, in the step 340, a gel body (or curable polymer) 250 (as shown in FIG. 7˜FIG. 10) is providing for fixing the relative positions between the metallic microspheres 210. During the step that the relative positions between the metallic microspheres 210 are fixed by the gel body (or curable polymer) 250, the magnetic device 240 may be used to draw the metallic microspheres 210 in the gel body (or curable polymer) 250 by magnetic force to firmly fix the relative positions between the metallic microspheres 210, which can prevent the arrangement of the metallic microspheres 210 from being destroyed by accident. When the diameter of the metallic microspheres 210 is 800 micrometers, the thickness of the gel body (or curable polymer) 250 may be, for example, between 0.1˜5.0 mm or may be, preferably, 2˜3 mm, which varies with the size of the metallic microspheres 210. Wherein, a portion of each metallic microsphere 210 can be exposed from the gel body (or curable polymer) 250, and each metallic microsphere 210 can also be completely embedded in the gel body (or curable polymer) 250. Said portion of each metal microsphere 210 exposes from the gel body (or curable polymer) 250 is used to reflect light to 3D space, which can produce 3D images viewable with naked eye and multi-view 3D images, and reduce the perspective phenomenon occurring in 3D images and enhance the image brightness and contrast. Besides, the method according to the present invention further comprises the step 350 of removing the adhesion layer 230 from the metallic microspheres 210 after the step 340 that the gel body (or curable polymer) 250 is provided for fixing the relative position between the metallic microspheres 210. For example, the adhesive removing agent 260 can be used to remove the adhesive layer 230 so as to expose a portion of each metallic microsphere 210 from the gel body (or curable polymer) 250 to work as surfaces for reflecting light (as shown in FIG. 10 and FIG. 11).

With reference to FIG. 13 for the schematic view of the binocular parallax in each direction of the method for manufacturing the reflective 3D display device in accordance with the present invention. As shown in FIG. 13, the positions and angles of the reflected lights vary with the surface of metallic microspheres or microspheres made of other materials with optical reflective feature, which can produce 3D images, enhance image brightness and contrast and reduce the perspective phenomenon occurring in 3D images. The shape of the metallic microspheres may be spherical, concave, polyhedral, geometrical or non-spherical.

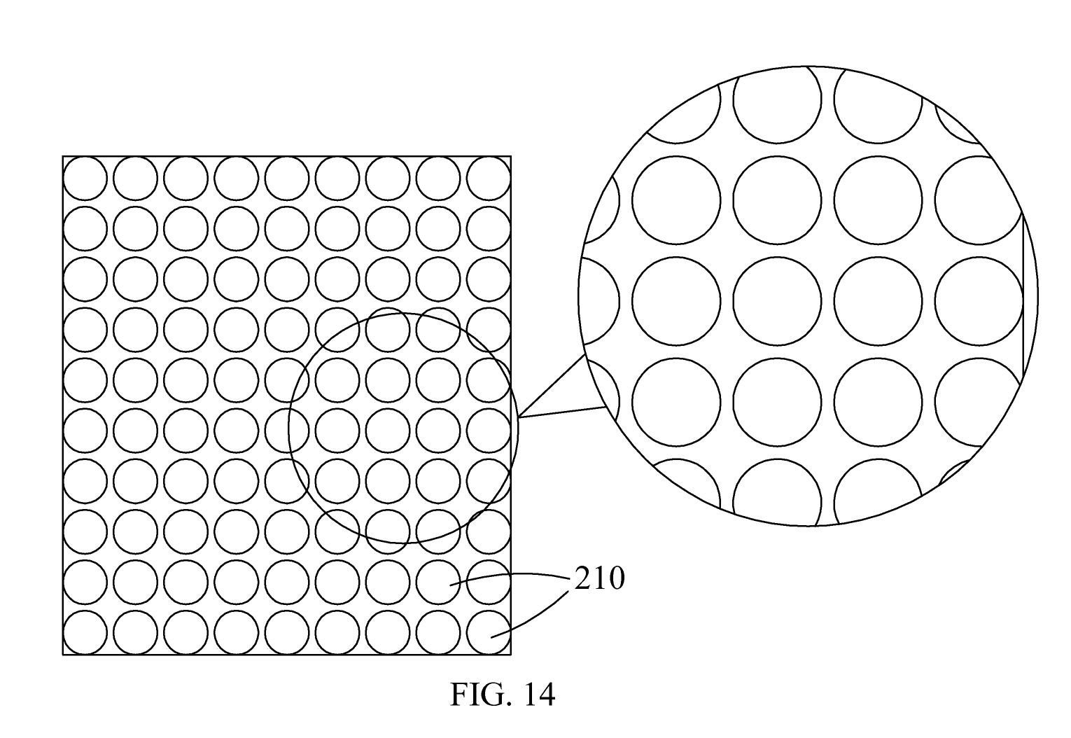

With reference to FIG. 13 for the schematic view of the metal microspheres arranged to form a simple cubic structure or a body-centered cubic structure of the method for manufacturing the reflective 3D display device in accordance with the present invention. As shown in FIG. 14, the metallic microspheres 210 are orderly arranged to form the body-centered cubic structure according to the intrinsic potential of each metallic microsphere 210 after the template is tilted to form the first included angle, between the cuboid-shaped template and a horizontal plane, in a first direction, and a second included angle between the cuboid-shaped template and the horizontal, in a second direction. In addition, the metallic microsphere 210 may be orderly arranged to form the face-centered cubic structure by changing the first and the second included angles.

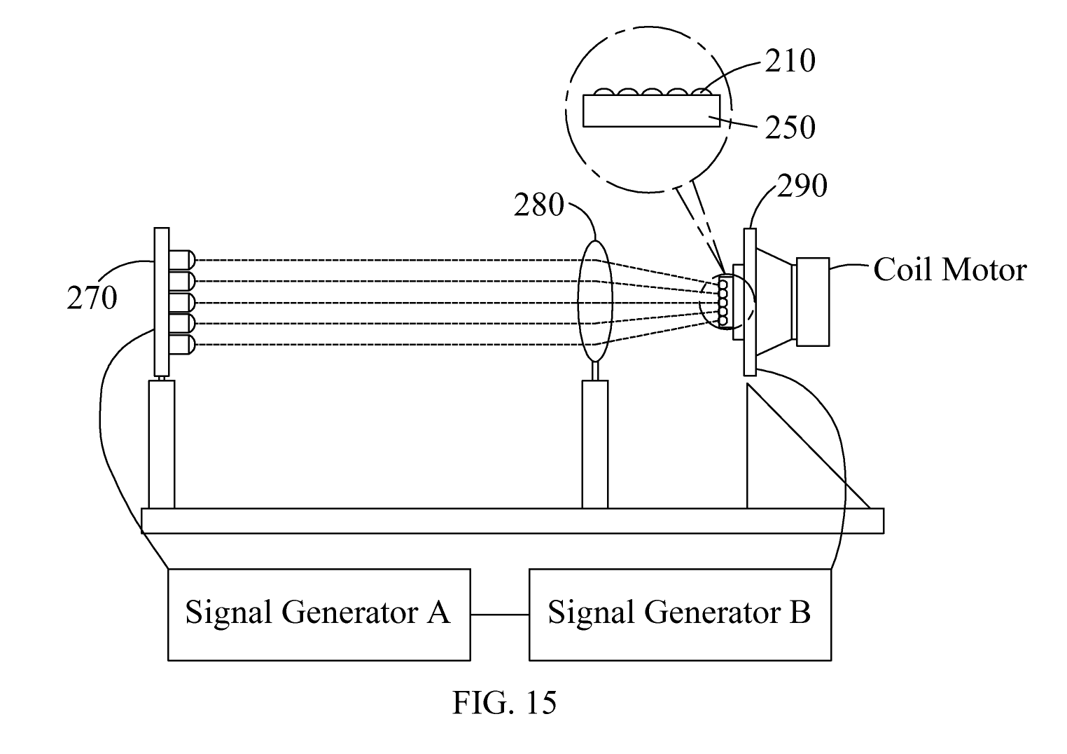

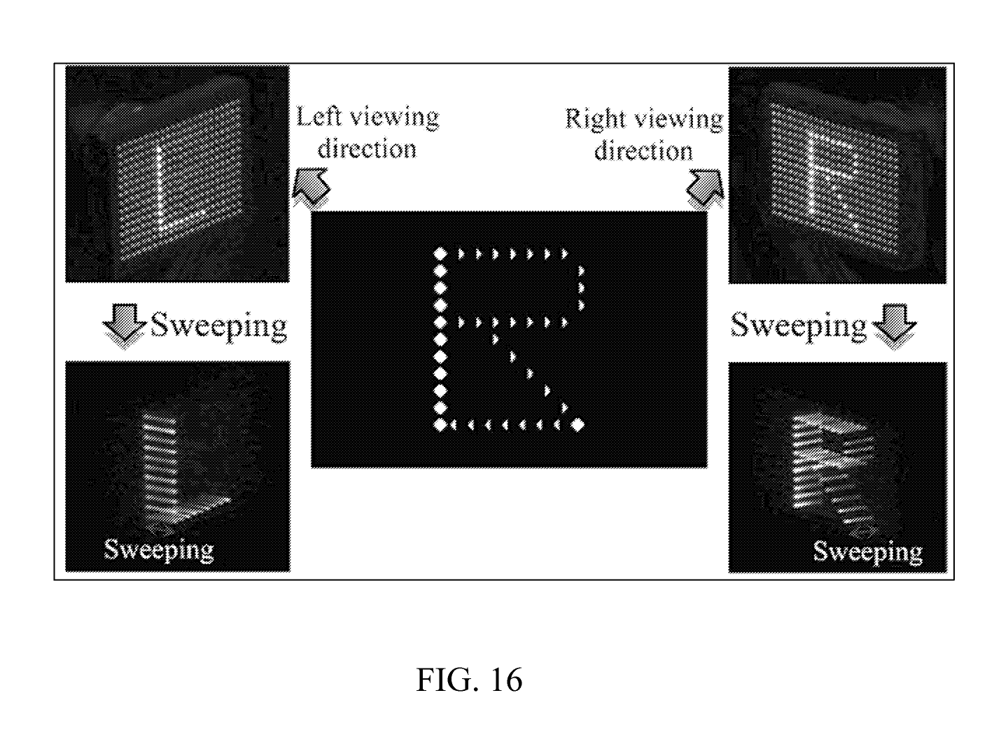

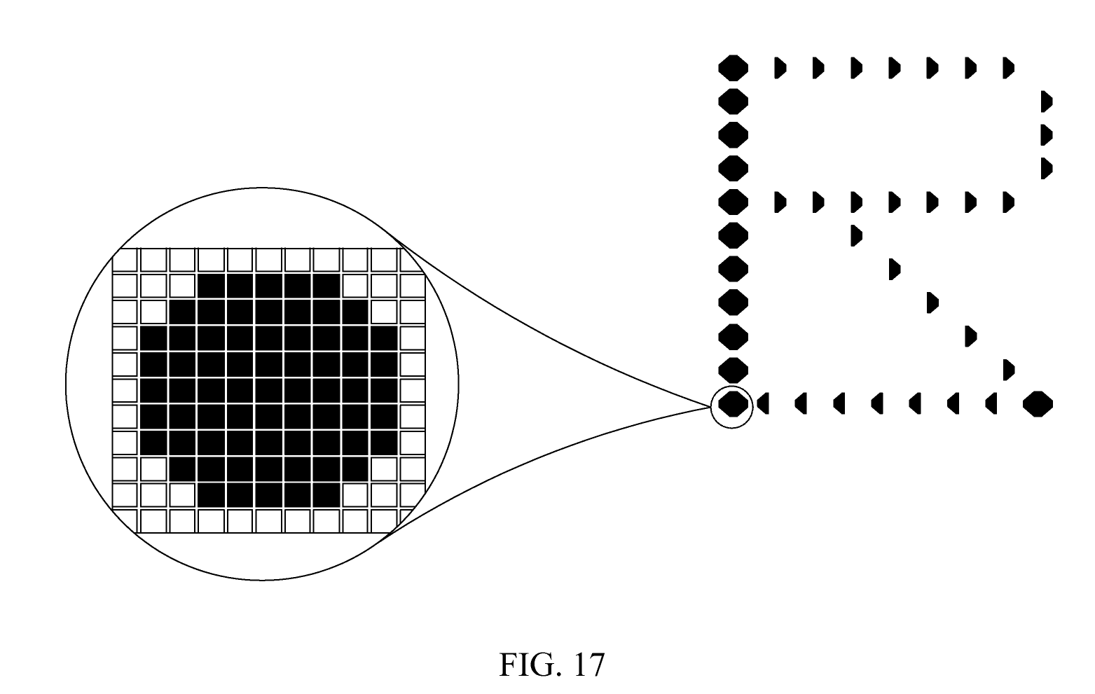

With reference to FIG. 15 for the schematic view of the reflective 3D display device in accordance with the present invention. The present invention further provides a reflective 3D display device which comprises a light emitting diode array 270, a focusing lens 280, and a reflective display screen 290 fixed on the coil motor and two signal generators. The reflective display screen 290 comprises the plurality of metallic microspheres 210 for reflecting light to 3D space and the gel body (or curable polymer) 250 for fixing the relative position of the metal microspheres 210. Wherein, the plurality of metallic microspheres 210 are embedded in the gel body (or curable polymer) 250 and a portion of each metallic microsphere 210 exposes from the gel body (or curable polymer) 250 for reflecting light to 3D space in order to produce 3D images viewable with naked eye and multi-view 3D images, and reduce the perspective phenomenon occurs in 3D images.

The arrangement of the metallic microspheres 210 may be body-centered cubic (b.c.c) or face-centered cubic (f.c.c). The thickness of the gel body (or curable polymer) 250 may be between 0.1˜5.0 millimeters. The shape of the metallic microspheres 210 may be spherical, concave, polyhedral or geometrical.

With reference to FIG. 16 for the schematic view of the reflective 3D display device in accordance with the present invention. FIG. 16 shows the image pattern which produced by pixel-mapping process. The image pattern is projected to reflective screen. The incident lights can be reflected separately to a predetermined orientation. In this way, users can watch different image patterns from different viewing directions. That can reduce the perspective phenomenon in traditional volumetric 3D display images by this imaging method.

With reference to FIG. 17 for the schematic views of the reflective 3D display device in accordance with the present invention. As shown in FIG. 17, each of the voxels in the image pattern may consist of a group of pixel array. Each pixel is aligned to a predetermined location on a metallic microsphere and is reflected to a specific orientation in space. Only selected pixels are illuminated. Wherein, the surface for reflecting light of the exposed portion of each of the metallic microspheres for reflecting light from is well aligned to the imaging pixel generated by the projector.

According to FIG. 16, a self-organized microsphere array according to the present invention can be used to generate multi-view three-dimensional image. The projected image pixels need to have precision alignment to the spherical reflective region. A screen made of simple cubic microsphere lattice has lower fill factor than hcp lattice, however, it is easy to use and easy to align. It can yield improved contrast.

In summation of the description above, the reflective 3D display device and the method for manufacturing the same according to the present invention can make the metallic microspheres self-organize and then arrange themselves to form the body-centered cubic structure or the face-centered cubic structure by tilting the template to form the first and the second included angle between the concave parts-trap and the horizontal plane. After that, the arranged metallic microspheres are removed by the adhesive layer and fixed by the gel body. The surface of the arranged metallic microspheres can be used to reflect light to 3D space, which can produce 3D images viewable with naked eye and multi-view 3D images, and reduce the perspective phenomenon occurring in 3D images.

While the means of specific embodiments in present invention has been described by reference drawings, numerous modifications and variations could be made thereto by those skilled in the art without departing from the scope and spirit of the invention set forth in the claims. The modifications and variations should in a range limited by the specification of the present invention.

What is claimed is:

1. A method for manufacturing reflective three-dimensional (3D) display device, applicable to a screen of a display device, comprising the following steps of:
providing a template with at least one concave parts-trap and at least one metallic microsphere;
tilting the template to form a first included angle, between the concave parts-trap and the horizontal plane, in a first direction, and a second included angle, between the concave parts-trap and the horizontal plane, in a second direction;
disposing the metallic microspheres in the concave parts-trap to make the metallic microspheres self-organize to intrinsic potential minima;
providing an adhesion layer to remove the metallic microspheres from the concave parts-trap; and
providing a gel body, for fixing the relative positions between each metallic microsphere, wherein a portion of each metallic microsphere exposes from the gel body in order to reflect light to 3D space, such that 3D images viewable with naked eye and multi-view 3D images are achieved, and the perspective phenomenon occurs in 3D images is reduced.

2. The method for manufacturing reflective 3D display device of claim 1, wherein the gel body is curable polymer.

3. The method for manufacturing reflective 3D display device of claim 1, wherein the arrangement of the metallic microspheres is simple cubic (s.c), body-centered cubic (b.c.c) or face-centered cubic (f.c.c) in the step that the at least one metallic microsphere is disposed in the concave parts-trap.

4. The method for manufacturing reflective 3D display device of claim 1, wherein the first included angle is between 0˜15 degrees.

5. The method for manufacturing reflective 3D display device of claim 1, wherein the second included angle is between 0˜15 degrees.

6. The method for manufacturing reflective 3D display device of claim 1, wherein the first included angle is equal to the second included angle.

7. The method for manufacturing reflective 3D display device of claim 1, further comprising the following step of:
removing the adhesion layer from the metallic microspheres after the step that the gel body is provided for fixing the relative positions between each metallic microsphere.

8. The method for manufacturing reflective 3D display device of claim 1, wherein the thickness of the gel body is between 0.1˜5.0 millimeters.

9. The method for manufacturing reflective 3D display device of claim 1, wherein the shape of the metallic microspheres is spherical, concave, polyhedral or geometrical.

10. The method for manufacturing reflective 3D display device of claim 1, wherein the metallic microspheres are mixed with isopropyl alcohol and then the isopropyl alcohol with the at least one metallic microsphere is dripped in the concave parts-trap during the step that the metallic microspheres are disposed in the concave parts-trap to make the metallic microsphere self-organize to the intrinsic potential minima.

11. A reflective 3D display device, comprising a light emitting diode array, a focusing lens and a reflective display screen, wherein the reflective display screen comprising:
a plurality of metallic microspheres, for reflecting light to 3D space; and
a gel body, for fixing the relative position of the metal microspheres;
wherein, the plurality of metallic microspheres are embedded in the gel body and a portion of each metallic microsphere exposes from the gel for reflecting light to 3D space in order to produce 3D images viewable with naked eye and multi-view 3D images and reduce the perspective phenomenon occurs in 3D images.

12. The reflective 3D display device of claim 11, wherein the gel body is curable polymer.

13. The reflective 3D display device of claim 11, wherein the arrangement of the metallic microspheres is simple cubic (s.c), body-centered cubic (b.c.c) or face-centered cubic (f.c.c).

14. The reflective 3D display device of claim 11, wherein the thickness of the gel body is between 0.1˜5.0 millimeters.

15. The reflective 3D display device of claim 11, wherein the shape of the metallic microspheres is spherical, concave, polyhedral or geometrical.

16. The reflective 3D display device of claim 11, wherein a surface for reflecting light of an exposed portion of each of the metallic microspheres for reflecting light from is aligned to an imaging pixel generated by a projector.
